(19) United States
(12) Patent Application Publication
(10) Pub. No.: US 2010/0129547 A1
(43) Pub. Date: May 27, 2010

(54) WASHCOATING HIGH POROSITY CERAMIC SUBSTRATES

(76) Inventors: Dayue David Jiang, Painted Post, NY (US); Mallanaguoda Dyamanagouda Patil, Corning, NY (US)

Correspondence Address: CORNING INCORPORATED, SP-TI-3-1, CORNING, NY, 14831, US

(21) Appl. No.: 12/578,962

(22) Filed: Oct. 14, 2009

Related U.S. Application Data
(60) Provisional application No. 61/118,052, filed on Nov. 26, 2008.

(51) Int. Cl. B05D 7/00

(52) U.S. Cl. 427/243

(57) ABSTRACT

A method of washcoating a high porosity honeycomb substrate is described that involves contacting the channels of the honeycomb with a solution of a viscosity raising material for a time sufficient to fill the pores of the honeycomb with the solution and viscosity changing material. When the pores come into contact with a washcoat slurry, the pH of the slurry at the pore site is changed and the viscosity of the slurry is raised such that it cannot enter the pores. Viscosity raising materials include water soluble polyamines. In one embodiment the polyamine is polyethylenimine. Amino-containing compounds having a molecular weight in the range of 300 to 50,000 can be used in practicing the invention.

### CROSS-REFERENCE TO RELATED APPLICATIONS

This application claims the benefit of priority under 35 U.S.C. §119(e) of U.S. Provisional Application Ser. No. 61/118,052 filed on Nov. 26, 2008.

### FIELD

The invention is directed to a method for washcoating cellular ceramic substrates such as ceramic honeycombs, and in particular to a method for washcoating high porosity cellular ceramic substrates with substantially no plugging the pores of the substrate with the washcoat, leaving the porosity of the substrate substantially unchanged.

### BACKGROUND

Ceramic honeycombs are used in a variety of applications including as particulate filters and flow-through catalysts for reducing pollutants such as CO, HC and NOₓ in engine exhausts. In many of these applications it is necessary to apply a “washcoat” material to the honeycomb before it can be used or further processed, for example, coating catalytic metals onto honeycombs. In some processes the honeycomb is first washcoated and the catalytic metals (for example, platinum, palladium and rhodium—all of which are very expensive) as applied to the washcoat after the washcoat has been dried and calcined. In other instances the catalytic metals are deposited onto the washcoat material and the washcoat is then applied to the honeycomb. In either case, washcoat that fills the pores of the honeycomb reduces porosity and also increases the amount of the expensive catalytic metal-coated washcoat that is used.

U.S. Pat. No. 5,346,722 relates to a method for improving the thermal shock resistance of a washcoated buffer solution to prevent wash from entering into the microcracks of a substrate by forming a gel with the washcoat at the surface of the microcracks. U.S. Pat. No. 4,451,517 relates to a method for improving the thermal shock resistance of a honeycomb by filling the microcracks of the honeycomb with an organic material prior to washcoating so that the washcoating does not enter the microcracks. The organic material is subsequently burned away. U.S. Pat. No. 4,483,940 relates to enhancing crack resistance by coating honeycomb surface with a high molecular weight organic which is burned away after washcoat deposition resulting in a gap between the honeycomb walls and the washcoat that improves thermal shock resistance. U.S. Pat. No. 4,532,228 also relates to filling honeycomb microcracks with an organic material that is subsequently burned away. While the foregoing patents describe methods for improving thermal shock resistance, none of them disclose coating a highly porous honeycomb with a washcoat such that the porosity of the honeycomb is substantially unchanged after the honeycomb is washcoated.

### SUMMARY

The invention discloses method for washcoating a highly porous honeycomb with a washcoat such that the porosity of the honeycomb is substantially unchanged after washcoating. In particular, the invention discloses a method for coating a highly porous honeycomb with a washcoat such that the porosity of the honeycomb is substantially unchanged and without leaving a gap between the washcoat and the material of the honeycomb walls after the coated honeycomb has been calcined. The washcoat thus adheres well to the walls of the honeycomb.

The invention describes a method for washcoating a high porosity honeycomb substrate. It includes the steps of:

providing a honeycomb substrate having a plurality of channels having walls therethrough from a first end to a second end and pores with said walls; contacting the said channel walls with an aqueous solution containing a viscosity raising material for a time sufficient for said solution to enter the pores of the honeycomb;

draining the solution containing the viscosity raising material from the channels of the honeycomb;

contacting the channel walls with water and draining to thereby remove the viscosity raising material from the channel walls with removing the viscosity raising material from the pores with said walls; and

washcoating the walls of said honeycomb with an aqueous washcoat slurry;

wherein when said washcoating slurry contacts the viscosity raising material within the pores of said honeycomb and the viscosity of the washcoat slurry is raised at the site of contact such that the washcoat slurry cannot enter into the pores of the honeycomb.

The viscosity raising material is an aqueous solution of an amino-functionalized compound that can be a small molecular weight species (for example, tetraethylenepentamine (“TEPA”)) or an amino-containing oligomer/polymer (for example, polyamines, polyvinylamines, poly(amino-alcohol)s, amino-functionalized polymers, and amino-containing copolymers) that can change the pH of a washcoat slurry when in contact with said slurry. In certain embodiments the viscosity raising material is a water soluble polyamine. A few specific examples include TEPA, polyvinylamine polyethyleninime, poly(vinylalcohol-co-vinylamine), and poly(vinylpyrrolidone-co-dimethylaminoethylmethacrylate.

In some embodiments the solution containing the viscosity raising material has a pH in the range of 8-13. In other embodiments the solution of the viscosity raising material has a pH in the range of 8-12. In embodiments where the viscosity raising material is an aqueous solution of polyethylenimine, the pH in the range of 10-11.

In one embodiment the honeycomb is selected from the group consisting of cordierite and alumina-titanate honeycombs, said honeycombs being either “flow-through” honeycombs where the flow is through the channels from one end of the honeycomb to the other end or “particulate trap” honeycombs where alternating channels are plugged at one end such that exhaust gasses must flow through the walls between the channels and the particulate matter is deposited on the walls.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIGS. 1A and 1B are SEM image of a washcoated honeycomb substrate that has a porosity of 43%.

FIGS. 2A and 2B are SEM image of a washcoated honeycomb substrate that has a porosity of 62%

FIG. 3 is an illustration of the relationship between the viscosity of a washcoat slurry and pH.

FIG. 4 is an illustration of a ceramic honeycomb, which is a multi-channel ceramic substrate.

FIG. 5 depicts the structure of polyethyleninime.

FIG. 6 is an illustration of a two step vacuum washcoating process.

FIGS. 7A and 7B are optical images of a high porosity (62% porosity) honeycomb treated with polyethylenaime prior to washcoating.

### DETAILED DESCRIPTION

The invention will now be described in detail with reference to a few exemplary embodiments, as illustrated in the accompanying drawings. In describing the embodiments, numerous specific details may be set forth in order to provide a thorough understanding of the invention. However, it will be apparent to one skilled in the art that the invention may be practiced without some or all of these specific details. In other instances, well-known features and/or process steps may not be described in detail so as not to unnecessarily obscure the invention. In addition, like or identical reference numerals may be used to identify common or similar elements.

As used herein, the term “high porosity” means a ceramic honeycomb substrate (also called a multi-channel substrate) of any composition as known or as may become known in the art that can be used for automotive, diesel, stationary engine, or other use known or to become know in the art that requires the use of such substrates. High porosity honeycombs are deemed to have a porosity of greater than 45% as measured by mercury intrusion porosimetry (“MIP”). As also used herein the term “honeycomb” means any ceramic cellular substrate having any number of cells per square inch or centimeter and channels through the substrate from one end to the opposite end. Also as used herein the term “washcoat” means a coating of any material, which as presently known in the art; for example without limitation, an alumina coating that may contain other materials that promote oxidation reactions (for example without limitation, cerium oxide) and may or may not contain the noble metal(s) (for example, without limitation, platinum, palladium, rhodium, osmium, etc).

In automobile exhaust gas applications and in other applications where dimensional or structural stability is particularly desired, a monolithic ceramic structure or honeycomb is preferred. In preparing a monolithic catalyst it is usually most convenient to employ a refractory inorganic oxide or oxides disposed as a thin film on an inert carrier material which provides the structural support for the refractory inorganic oxide. The carrier material can be any refractory material. It is preferred that the carrier material be unreactive with the refractory inorganic oxide(s) and with the fluid or fluids (e.g., exhaust gases in the case of engines) to which it is exposed. Ceramic materials are a preferred class of carrier material. Examples of suitable ceramic materials include, but are not limited to, sillimanite, petalite, cordierite, mullite, zircon, zircon mullite, spodumene, alumina-titanate, and other ceramic material known in the art. The carrier material can best be utilized in any rigid, unitary configuration which provides a plurality of channels therethrough extending in the direction of gas flow. It is preferred that the carrier material be in a honeycomb configuration. For a more detailed discussion of monolithic structures, refer to U.S. Pat. Nos. 3,785,998 and 3,767,453. Other art relating to honeycomb catalysts and/or the washcoating process, including materials that can be used, include U.S. Pat. Nos. 5,953,832, 5,212,130, 5,206,202, 4,675,308, 4,526,886, 4,480,050, 4,171,280, and 4,053,566.

The refractory inorganic oxide, frequently call “washcoat material” can be deposited on the carrier material by any conventional or convenient means. It is preferred that the refractory inorganic oxide be deposited in the form of a film of from about 0.0003 to about 0.05 inches thick. It is also preferred that the refractory inorganic oxide be present on the carrier material in amounts in the range of from about 800 grams per cubic foot of carrier to about 4500 grams per cubic foot of carrier, where the volume is measured by the exterior dimensions of the carrier material. The deposition of the refractory inorganic oxide material on a honeycomb, whether alone or admixed with or having deposited thereon with other oxides and catalytic noble metals (e.g., Pt, Pd, Rh), is called “washcoating.” The catalytic components can be incorporated in the catalytic composite in any suitable manner in or on the refractory inorganic oxide, such as by coprecipitation, cogellation, ion-exchange, or impregnation by soaking, dipping, immersion, or otherwise. The preferred method of preparing the catalyst coated washcoat involves the use of a soluble, decomposable compound of the particular catalytic component to impregnate the refractory inorganic oxide in a relatively uniform manner. For example, a platinum and/or palladium component may be added to the refractory inorganic oxide by commingling the latter with an aqueous solution of chloroplatinic and/or chloropalladic acid. The chloroplatinic acid and chloropalladic acid can be in common aqueous solution, or in separate aqueous solutions. In the latter case, in instances in which both a platinum and a palladium component are desired, the commingling of the refractory inorganic oxide with the solutions can be performed sequentially in any other order. Other water-soluble compounds or complexes of platinum or palladium may also be used in the impregnation solutions as is known in the art. Likewise, when rhodium is a component of the catalyst it may be added to the refractory inorganic oxide by commingling the latter with an aqueous solution of rhodium trichloride. Other water-soluble compounds or complexes of rhodium may also be used.

Inorganic oxides that can be used as washcoat materials to washcoat a honeycomb include synthetic and naturally occurring refractory inorganic oxides such as alumina, titanium dioxide, zirconium dioxide, chromium oxide, zinc oxide, magnesia, thoria, boria, silica-alumina, alumina-boria, and others known in the art. The preferred refractory inorganic oxide is alumina. Suitable aluminas are the crystalline aluminas known as the gamma-, eta-, and theta-alumina, with gamma- or eta-alumina which give the best results. In addition, in some embodiments the alumina may contain other well-known refractory inorganic oxides such as silica, zirconia, magnesia, etc. The preferred alumina is substantially pure gamma- or eta-alumina.

The present invention is directed to a method for washcoating highly porous (greater than 45% porosity) multi-channel ceramic honeycombs. In certain embodiments the porosity is greater than 50%. The present invention is further directed to a washcoating process that includes the application of an aqueous solution of an amine, particularly an aqueous solution of a polyamine, into the pores of the ceramic substrate before conducting the washcoating using the refractory inorganic oxide. The quality of the washcoat, whether it contains catalytic metal(s) and/or other metals, or not, is controlled by two important parameters:

the washcoat loading; and

the dispersion of the washcoat—uniformly dispersed washcoat on the surface of the channel walls of the honeycomb provide for the best performance when catalyzed such as in auto exhaust catalysts.

When washcoating with a catalyst-bearing washcoat slurry onto a multi-channel ceramic substrate that has a relative low porosity, there is no significant problems regarding pore plugging by the washcoat slurry. The washcoat essentially is deposited onto channel surfaces as shown in FIGS. 1A and 1B which are SEM images of the multi-channel honeycomb X has a porosity of 43% and is coated with a catalyst-free, cerium-containing washcoat slurry are shown. FIG. 1A shows that none or essentially none of the washcoat 12 enters the pores of the honeycomb channel walls 14. That is, the pores of the high porosity honeycomb are substantially free of washcoat. FIG. 1B illustrates the part of FIG. 1A within the white-bordered box and was obtained use a Ce probe. FIG. 1B further illustrates that none of the cerium containing washcoat 12 has entered the honeycomb pores. This allows a honeycomb catalyst to function efficiently when catalyzed, for example by coating with a catalyst-bearing washcoat slurry onto the multi-channel ceramic substrate.

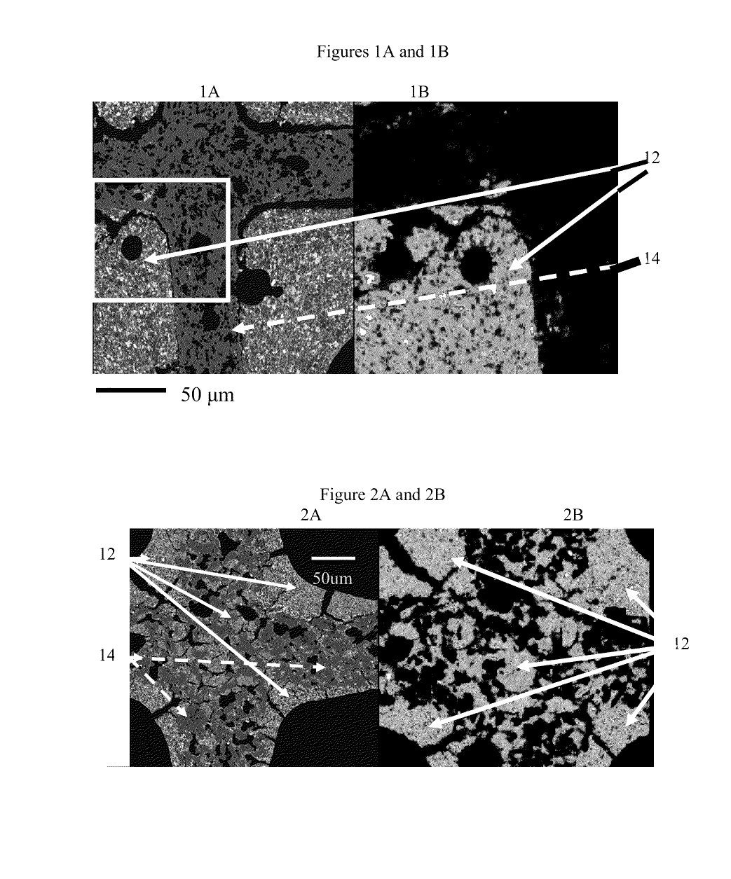

However, when a catalyst-bearing washcoat slurry is coated onto the channel walls of a ceramic substrate that with high porosity (high porosity is frequently related to a large pore sizes), the washcoating slurry enters the pores of the ceramic substrate as seen in FIGS. 2A and 2B which are SEM images of a high porosity honeycomb substrate Y that has a porosity of 62% that was not treated with a viscosity raising solution prior to washcoating. For exemplary purposes a high porosity honeycomb Y was coated with a cerium-containing, catalyst-free washcoat. FIG. 2A depicts the web intersection formed by the honeycomb's channel walls. The black areas are pores or the channels that are empty of any material. The lighter grey area is the washcoat 12 and the darker grey areas are the ceramic material of the honeycomb. FIG. 2B, obtained using the SEM cerium probe not only shows the effect on the porosity of the ceramic substrate when washcoat enters the honeycomb pores, but it also illustrates the amount of the expensive washcoat slurry that has to be used to coat the honeycomb and the reduced the efficiency of the washcoat loading (when catalyzed) due to pore filling.

The present invention is directed to a method/process that addresses a pressing need in the field—namely, a washcoating method by which the washcoat slurry will only be coated onto the surface of the channel wall of the ceramic substrate (e.g., a honeycomb) that has high porosity.

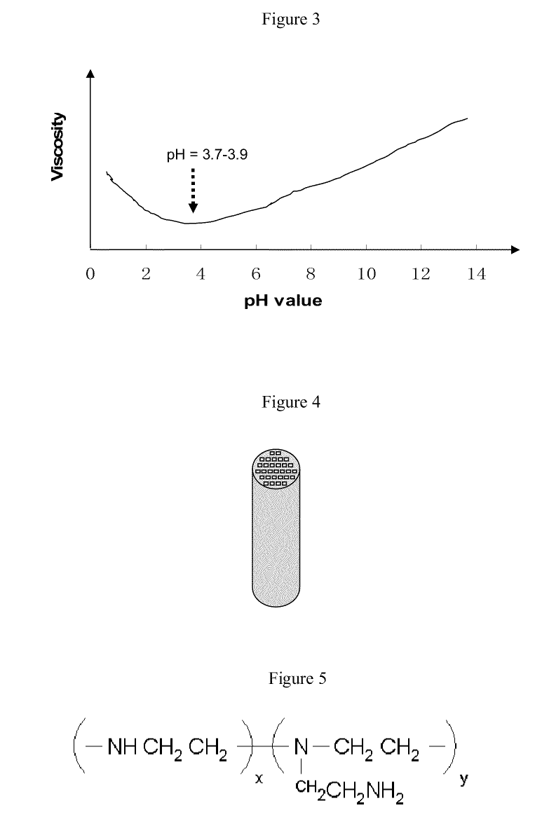

One feature of washcoat slurries is that their viscosity changes with changes in the pH of the slurry as is illustrated in FIG. 3 for an alumina slurry. The washcoat slurry illustrated by FIG. 3 reaches its lowest viscosity at a pH in the range of 3.70 to 3.90. Refractory inorganic oxide slurry materials other than alumina may have a different pH range for their minimum viscosity or the minimum viscosity of an alumina slurry may change in the present of other refractory inorganic oxides. Consequently, either a strong acidic solution or a basic solution can be used to change the pH value of a washcoat slurry, and thus the change of the viscosity of the washcoat slurry. Since the washcoat slurry illustrated in FIG. 3 has its lowest viscosity in the pH range of 3.70 to 3.90, coating of honeycomb walls is easily done without plugging of the honeycomb channels, or with minimal plugging. However, the low viscosity of the washcoat slurry also makes it easy for the washcoat to enter the pores of high porosity honeycombs (high porosity is related to a larger pore size). Because the viscosity of the washcoat slurry changes with the change of the pH value, this washcoat property has been utilized herein to achieve a process by which the viscosity of the washcoat slurry is at its optimal range (pH of 3.70-3.90) as its flows through the channels, but the viscosity is made to increase when the washcoat tries to enter the pores of the honeycomb. The increase in viscosity effectively preventing the washcoat slurry from entering the inside of the pores of the ceramic substrate.

In accordance with the invention, an aqueous solution of an amine, preferably a polyamine and more preferably an aqueous solution of polyethylenimine (hereafter “PEIm”) is used to increase washcoat viscosity when the washcoat tries to enter the pores of the honeycomb. PEIm (molecular formula: (C₂H₅N)ₙ, CAS No: 9002-98-6) is a commercially available, environmentally benign polyamine material that is widely used in printing, adhesives, cosmetics, paper coatings, fixatives, and as a flocculant, dispersant, stability enhancer and for other purposes. In accordance with the invention the pores of the honeycomb were filled with an aqueous solution of the PEIm before the washcoating process was begun. When PEIm comes into contact with the washcoat it significantly changes the pH value of the washcoat slurry at the localized pore area by making the slurry less acidic (pH>3.90) and thus causes an increase in the viscosity of the washcoat slurry at the pore site. As a result of the localized increase in viscosity, PEIm acts to block entry of the washcoat slurry at the pore cite without affecting the viscosity of the bulk slurry passing through the honeycomb channels.

When the washcoating process has been completed the channels are cleared of slurry by allowing them to drain with or without air flow through the channels. The washcoated honeycomb was then calcined at a temperature and for a time sufficient to form the washcoated substrate (for example as described in U.S. Pat. No. 5,346,722). While the calcination conditions will vary with the specific slurry composition, size and configuration of the honeycomb and other process conditions, in general the washcoat calcination is carried out at a temperature in the range of 500-800° C. for a time in the range of approximately 30 minutes to 6 hours, particularly for alumina washcoats (with or without noble metals on the washcoat and other additives in the washcoat). Exemplary washcoats are described in U.S. Pat. No. 5,346,722 as, in wt. % with water as the slurry medium:
Washcoat 1: about 30% CeO₂; about 10% ZrO₂ or BaO or combinations; about 3% La₂O₃ or BaO, or combinations; and about 57% gamma-Al₂O₃, or SiO₂, or La₂O₃ or ZrO₂, or combinations.
Washcoat 2: 20-30% CeO_{2,} 2-10% La₂O_{3,} 2-20% ZrO₂ and balance gamma-Al₂O₃.

Polyamines, and in particular polyethylenimine (PEIm) used herein as an exemplary polyamine, are environmentally benign polymers. In accordance with the invention, a selected polyamine, for example, PEIm, must be readily soluble in water so that an aqueous solution can be obtained and the polyamine easily applied to the honeycomb. Selected amines should be those that give an aqueous solution whose pH is in the range of 8-13, preferably in the range of 9-12. PEIm is basic because of the amino-groups and thus it can be used to change the pH value of the washcoat slurry and hence can affect the viscosity of the washcoat slurry significantly. PEIm is a viscous liquid (the viscosity depending on molecular weight) that is readily soluble in water to give a solution having a pH in the range of 10-11. Other polyamines and polymers, including copolymers that are functionalized by amino-groups, can also be used in practicing the invention provided that they change the pH, and hence the viscosity, of the slurry to be outside the range 3.70-3.90. In preferred embodiments the pH (at the pore site) is changed to be >3.90.

Although a vacuum washcoating coating process was used to washcoat honeycombs as is described herein, other washcoating methods known in the art can also be used; for example, dip coating and other coating process. The vacuum, dipping and other processes can also be used to fill the honeycomb pores with a solution of the polyamine material. The polyamine can be linear with terminal amino groups or it can be branched with pendent amino groups or pendent alkyl groups having a terminal amino group (e.g., —(CH₂)_{z}—NH₂, where z is in the range of 1-6, preferably in the range of 2-4). Referring to PEIm (and other amino-containing compounds as described herein), the molecular weight of the PEIm can be low (e.g., MW=300) or high (e.g., MW=50,000). A PEIm (or other amino-containing compounds as described herein) with a relatively low molecular weight in the range of 300 to 5,000 is preferred. The concentration of the aqueous solution of the PEIm (or other amino-containing compounds as described herein) can be low or high; for example, the concentration can be, in weight percent (wt. %), from 1% to 50% or higher. In preferred embodiments the PEIm concentration is in the range of 5 to 20% is preferred. If other polyamines are used the concentrations and molecular weight ranges may vary from those described herein and can be easily determined using the teaching herein. The method can be extended to other polyamines, such as polyvinylamine; to poly(amino-alcohol)s, such as poly(vinylalcohol-co-vinylamine); to other amino-functionalized polymers, poly(vinylpyrrolidone-co-dimethylaminoethylmethacrylate); to non-volatile amines and other basic solutions as well as other solutions that can change the pH value of the washcoat slurry when contacted with the slurry.

Coating the Honeycomb with Polyamine Solution

A multi-channel honeycomb substrate was soaked in an aqueous PEIm solution for a time in the range of 1-10 minutes at ambient temperature which is typically in the range of 18-30° C. During the soaking process the pores of the ceramic substrate became saturated by the PEIm solution. The PEIm solution also filled the channels of the ceramic substrate. After soaking the honeycomb is removed from the PEIm solution and allowed to drain. Optionally, the PEIm solution was blown out of the honeycomb channels using forced air. The PEIm solution was cleared from the channels, but remained in the pores of the honeycomb substrate due to attractive forces. Once the channel were cleared of the PEIm solution, the PEIm remaining on the surface of the channel walls can optionally be removed by soaking the honeycomb in water (or rising it with water) for a time in the range of 10 seconds to 5 minutes. PEIm on the channels walls can be removed because its presence may affect the affinity between the channel wall and the washcoat. If the PEIm remains on the channel walls the washcoat slurry may not properly adhere to the channel walls. The rinsing water will enter the channels but not the pores because the pores have been filled with the PEIm solution. The PEIm attached on the surface of the channel walls dissolves into the water and is blown out with the water by forced air. In preferred embodiments the PEIm is washed out from the channel walls to maximize washcoat adhesion to the channel walls. When the washcoating was completed, the washcoat slurry was attached onto the surface of the channel walls and did not enter into the pores because the presence of the PEIm solution in the pores of the honeycomb significantly changed the viscosity of the washcoat slurry at pore sites to prevent it from entering the pores. This procedure differs from the known art (for example, U.S. Pat. No. 4,483,940 cited above, which disclosed enhancing crack resistance by coating channel walls with an organic material that is burned away after washcoating to leave a gap between the honeycomb walls and the washcoat), because a polyamine such as PEIm (or other viscosity increasing material) affects washcoat properties such as the good adhesion that is required. The polyamine, or other viscosity increasing material can thus be removed from the channel walls as indicated herein in order to avoid the possibility of forming any gaps between the washcoat and the channel walls.

FIG. 6 is a schematic illustration of a coating process that can be used in practicing the invention. Details of the washcoating process are given in Examples I to III. With this method, not only can the washcoating slurry be prevented from entering the inside of the pores of the ceramic substrate but it also has little effect on the affinity/interaction between the washcoat and the channel surface of the ceramic substrate.

Although the vacuum coating method was used to exemplify the invention, other coating methods known in the art, for example, dip coating, can also be used. The vacuum coating method described herein is a wet process. Other processes using a partially dry or a dry honeycomb that has been soaked by the PEIm solution and then washed by water can also be used because the PEIm is not volatile and will remain inside of the pores even after the ceramic substrate has been dried.

### Example 1

### Preparation of the PEIm Aqueous Solution

A honeycomb was treated using a 10% aqueous PEIm solution. A 250 mL jar was charged with 20 g PEIm and 180 g water. An exothermal reaction is observed as the PEIm dissolves in the water. This PEIm and water were mixed well until clear solution was obtained and was ready for use.

### Example 2

### Applying PEIm Aqueous Solution and then Water onto Ceramic Substrate

The multi-channel honeycomb placed in the 250 mL jar containing the PEIm solution where is soaked in and saturated by the polyamine aqueous solution. The honeycomb was removed from the jar and PEIm aqueous solution in the inside of the channels was blown out using forced air while the polyamine solution attracted by the pores of the ceramic substrate remained in the pores.

The procedure was repeated, this time using water to in place of the PEIm aqueous solution. This allows the PEIm on the surface of the honeycomb's channel walls to be washed out without affecting the PEIm solution in the pores. The honeycomb was removed from the water, drained and forced air was used to blow out any residual water in the channels,

### Example 3

### Coating the Washcoat Slurry onto the Multi-Channel Ceramic Substrate

Once the PEIm has been applied to the pores of the honeycomb, the honeycomb (in wet form, partially dried form or dried form) is ready for washcoating. FIG. 6 illustrates a vacuum washcoating process that was carried out in two steps. In the first step, illustrated on the left, the honeycombs 100 was placed inside a vacuum tube 102 (illustrated by broad black lines in only one instance) in the vertical position. The vacuum 104 was turned on and a vessel 106 containing the washcoat slurry (not illustrated) was raised to cover about one-half the height of the honeycomb. The diameter of the vessel 106 is only slightly larger than that of the honeycomb/vacuum tube assembly, and the amount of slurry in the vessel was sufficient to fill one half of the honeycomb channels' volume. As illustrated in FIG. 6, left side, Z1 represents the zone of the honeycomb that contains the washcoat and Z2 represents the zone that does not contain washcoat. The washcoat is contacted with the channel walls for a time in the range of 30 seconds to 1 minute. The vacuum is then released, the vessel is lowered and the slurring allowed to drip our. The honeycomb/vacuum tube assembly is then inverted as indicated by arrow 108 such that the washcoated zone Z1 is on top of unwashcoated zone Z2. The vacuum 104 turned on, vessel 106 is raised and the washcoat is pulled into the honeycomb channels to coat zone Z2. A honeycomb having all channel walls coated with washcoat is illustrated as 110. When the washcoating is completed the washcoated honeycomb is calcined as described above.

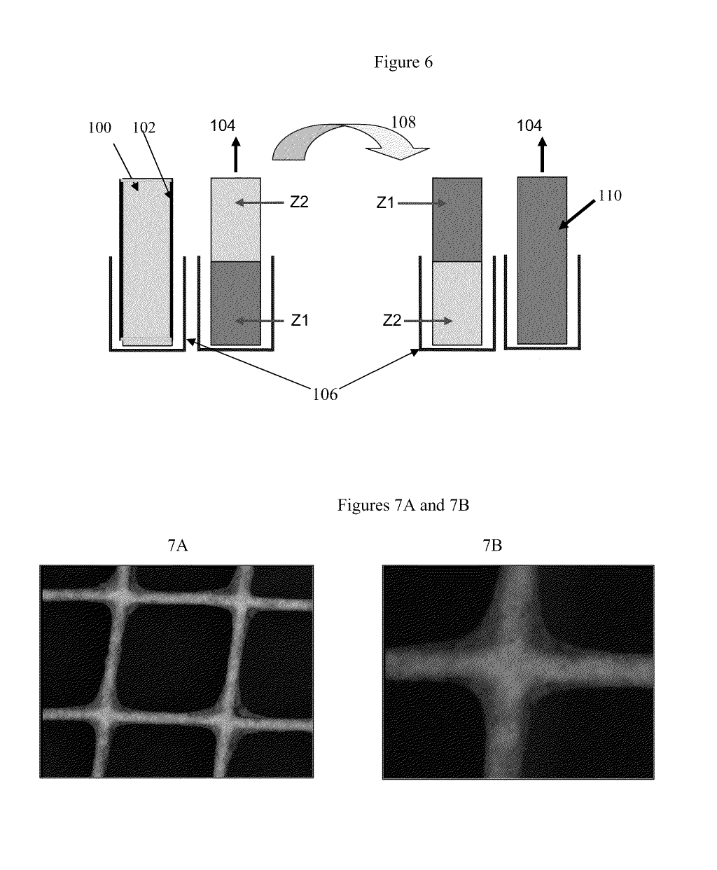

FIGS. 7A and 7B show optical images of a high porosity honeycomb substrate Y that was washcoated using the method describes in the above Examples 1-3. The images show that the washcoat slurry was effectively blocked from entering the honeycomb pores by the PEIm solution. The washcoat essentially coated the surface of the honeycomb's channel walls.

Other methods for washcoating honeycombs that have been described in the art can also be used to washcoat high porosity honeycomb substrates, provided that the pore of the substrate are willed with a polyamine or other viscosity increasing material.

While the invention has been described with respect to a limited number of embodiments, those skilled in the art, having benefit of this disclosure, will appreciate that other embodiments can be devised which do not depart from the scope of the invention as disclosed herein.

We claim:

1. A method for washcoating a high porosity honeycomb substrate, said method comprising the steps of:
providing a honeycomb substrate having a plurality on channels having walls therethrough from a first end to a second end and pores with said walls;
contacting the said channel walls with an aqueous solution containing a viscosity raising material for a time sufficient for said solution to enter the pores of the honeycomb;
draining the solution containing the viscosity raising material from the channels of the honeycomb;
contacting the channel walls with water to thereby remove the viscosity raising material from the channel walls with removing the viscosity raising material from the pores with said walls; and
washcoating the walls of said honeycomb with an aqueous washcoat slurry;
wherein when said washcoating slurry contacts the viscosity raising material within the pores of said honeycomb, the viscosity of the washcoat slurry is raised at the site of contact such that the washcoat slurry cannot enter into the pores of the honeycomb.

2. The method according to claim 1, wherein the viscosity raising material is a water soluble polyamine.

3. The method according to claim 1, wherein the viscosity raising material is a water soluble amino-functionalized compound having a molecular weight in the range of 300 to 50,000.

4. The method according to claim 1, wherein the viscosity raising material is a water soluble amino-functionalized compound has a molecular weight in the range of 300 to 5,000.

5. The method according to claim 1, wherein the viscosity raising material is selected from the selected from the group consisting of polyvinylamines, poly(amino-alcohol)s, amino-functionalized polymers, and amino-containing copolymers that can change the pH of a washcoat slurry when in contact with said slurry, the foregoing compounds having a molecular weight in the range of 300 to 5,000.

6. The method according to claim 1, wherein honeycomb is selected from the group consisting of cordierite and alumina-titanate honeycombs.

7. The method according to claim 1, wherein the solution containing the viscosity raising material has a pH in the range of 8-13.

8. The method according to claim 1, wherein the solution containing the viscosity raising material has a pH in the range of 9-11.

9. The method according to claim 1 wherein the solution containing the viscosity raising material is an aqueous solution of polyethylenimine having a pH in the range of 10-11.

10. The method according to claim 1, wherein the honeycomb has a porosity of greater that 45% as measured by mercury infusion porosimetry.

11. The method according to claim 1, wherein the concentration of the viscosity raising material in the aqueous solution said material is in the range of 1 wt. % to 50 wt. %

12. The method according to claim 1, wherein the concentration of the viscosity raising material in the aqueous solution said material is in the range of 5 wt. % to 20 wt. %.
